(19) United States
(12) Patent Application Publication
(10) Pub. No.: US 2007/0244911 A1
(43) Pub. Date: Oct. 18, 2007

(54) Composite clinical data dictionary (C²D²)

(76) Inventor: Richard S. Dick, Alpine, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/385,427

(22) Filed: Mar. 21, 2006

(51) Int. Cl. G06F 7/00

(52) U.S. Cl. 707/100

(57) ABSTRACT

A system and method for taking data from a known source, breaking it down into its most generic, atomic form, and in so doing removing all ambiguity, and translating the generic data into any type of application. For example, and not by way of limitation, this system and method breaks down personal data into the most atomic, generic form possible such that there can be no ambiguity as to the identity of the person or as to the accuracy and semantic meaning of the data related to that person, with such generic, atomic-level information transferable into any type of digital application or transaction.

### BACKGROUND OF THE INVENTION

1. Field of the Invention

A system and method for taking data from a known source, breaking it down into its most generic, atomic form, and in so doing removing all ambiguity, and translating the generic data into any type of application. For example, and not by way of limitation, this system and method breaks down personal data into the most atomic, generic form possible such that there can be no ambiguity as to the identity of the person or as to the accuracy and semantic meaning of the data related to that person, with such generic, atomic-level information transferable into any type of digital application or transaction.

2. Background and Related Art

In today's digital world, people and institutions transfer information easily and quickly via the Internet or other computer-related technologies and applications. While easily transferable, the information is not always usable and accurate. To ensure information is usable to many, companies often collaborate to ensure their applications are compatible. To solve this problem, standards are often the solution, with many companies using a common standard to ensure maximum interoperability. While standards are useful, they have a common shortcoming of failing to break down data into its most atomic, generic form. This hinders the transfer of data not conforming to the standard and is costly to companies because one or more format conversions are often needed to facilitate the data transfer.

In addition, because current technologies fail to break down data into its most atomic, generic form, the data often contains ambiguities that result in the inaccurate transfer of data or the inaccurate interpretation of such data. While problematic for every industry, this presents particular problems in the medical and financial industries. For instance, the inaccurate transfer or interpretation of medical records can result in inaccurate diagnosis or treatment. Similarly, the inaccurate transfer of personal financial information can result in personal financial harm in the form of identity theft or harm to one's credit rating. Thus, it is clear that a need exists for a method and system that solves these data transfer problems.

### SUMMARY OF THE INVENTION

A system and method for taking data from a known source, breaking it down into its most generic, atomic form, and in so doing removing all ambiguity, and translating the generic data into any type of application. For example, and not by way of limitation, this system and method breaks down personal data into the most atomic, generic form possible such that there can be no ambiguity as to the identity of the person or as to the accuracy and semantic meaning of the data related to that person, with such generic, atomic-level information transferable into any type of digital application or transaction.

In some embodiments of the present invention, the present invention addresses interoperability between disparate computer systems and data originating from any system to be translated to any other system and to remove all ambiguity in the data elements by specifying the data elements at the atomic level. In some embodiments, the present invention uses at least one of the following: data dictionaries, atomic-level structures, XML, interoperability, data exchange, data accuracy, and data transformation.

In other embodiments of the present invention, the present invention addresses interoperability and recognizes that a main challenge to improving interoperability lies in the ambiguity of the data. The present invention recognizes that as long as one can interpret data in multiple ways, it is unlikely that people or systems will accurately translate data between disparate systems. Therefore, in an attempt to solve this problem, the data must first be transformed as it is extracted from one system and be translated into an atomic-level structure whereby the data elements themselves are defined at the atomic level, where the present invention removes all ambiguity. The present invention reassembles the atoms in such a way that one can configure a data stream that looks exactly like the data stream that another (e.g. a different vendor) might expect as an input stream.

For example, the personal name of an individual is different in different parts of the world. In fact, in some parts of the world, the notion of a last name does not exist. In other parts of the world, one assembles official parts of a name, such as an academic title, in a different manner. For instance, in most English-speaking countries one appends the M.D., R.N., or Ph.D. degree, or other academic suffixes to the name, as suffixes to the name. However, in Japan one places the academic credentials at the beginning or prior to the proper name rather than following it. Therefore, by having the atomic-level elements such as those suffixes individually identified, one can place them in any sequence desired. Therefore, the atomic-level structure permits the maximum flexibility in addressing any situation that may arise and allows one to piece the data together in an approach that is acceptable or needed in a data exchange environment. In sum, in some embodiments of the present invention, the present invention removes the ambiguity, structuring the data at the atomic level, and then deals with data-exchange issues, in any way that may be required because the present invention has generated unambiguous data. With unambiguous data, one can deal with the data according to any rules that one may need to appropriately address manipulations of the data in an interoperability setting or data exchange setting.

An advantage of the approach of some embodiments of the present invention is the ability to extract data from proprietary data formats in any of the disparate feeder systems. In these embodiments, the present invention can extract data from those systems without any cooperation or assistance from the vendors who provide or manufacture those systems, transform the data without their assistance and create a functional interoperability environment without any disruption, participation, or assistance provided from the vendors who insist on utilizing those internal proprietary formats.

While the methods and processes of the present invention have proven to be particularly useful in the areas of data transfer, those skilled in the art can appreciate that the methods and processes can be used in a variety of different applications and in a variety of different areas of manufacture to yield taking data from a known source, breaking it down into its most generic, atomic form, and in so doing removing all ambiguity, and translating the generic data into any type of application.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative system that provides a suitable network operating environment for use of the present invention;

FIG. 3 illustrates the relationships among the four quadrants of four aspects of the present invention; and

FIG. 4 illustrates an example of the development of the “Atomic-level” data dictionary.

### DETAILED DESCRIPTION OF THE INVENTION

A system and method for taking data from a known source, breaking it down into its most generic, atomic form, and in so doing removing all ambiguity, and translating the generic data into any type of application. For example, and not by way of limitation, this system and method breaks down personal data into the most atomic, generic form possible such that there can be no ambiguity as to the identity of the person or as to the accuracy and semantic meaning of the data related to that person, with such generic, atomic-level information transferable into any type of digital application or transaction.

While this disclosure focuses on applying the invention to personal information, one skilled in the art will recognize the present invention's applicability to all kinds of information and that by definition, references to personal information also include applications to other types of data.

The following disclosure of the present invention is grouped into 2 subheadings, namely “Exemplary Operating Environment” and “Composite Clinical Data Dictionary (C²D²).” The utilization of the subheadings is for convenience of the reader only and is not to be construed as limiting in any sense.

### Exemplary Operating Environment

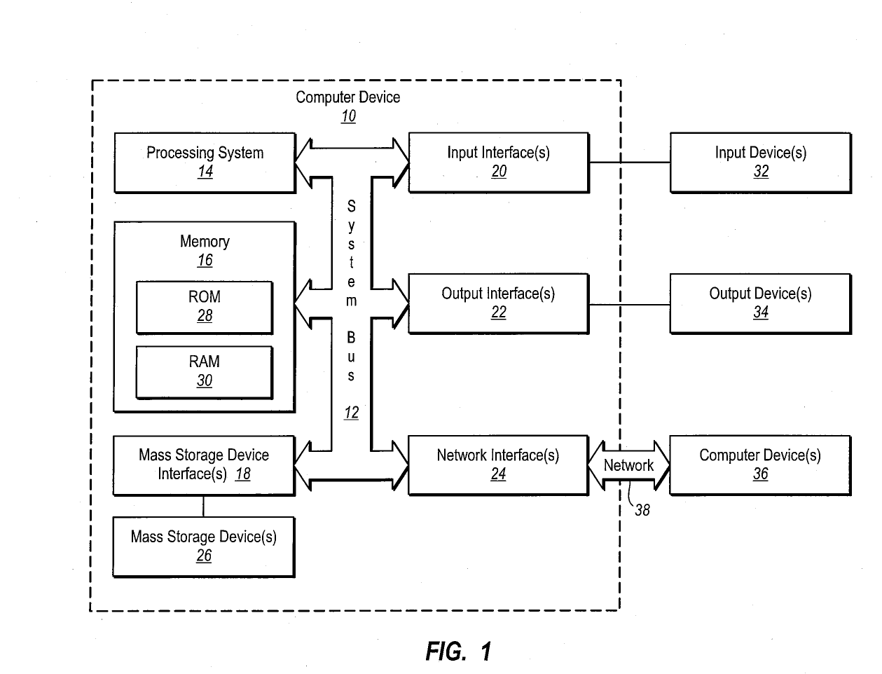

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Some embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

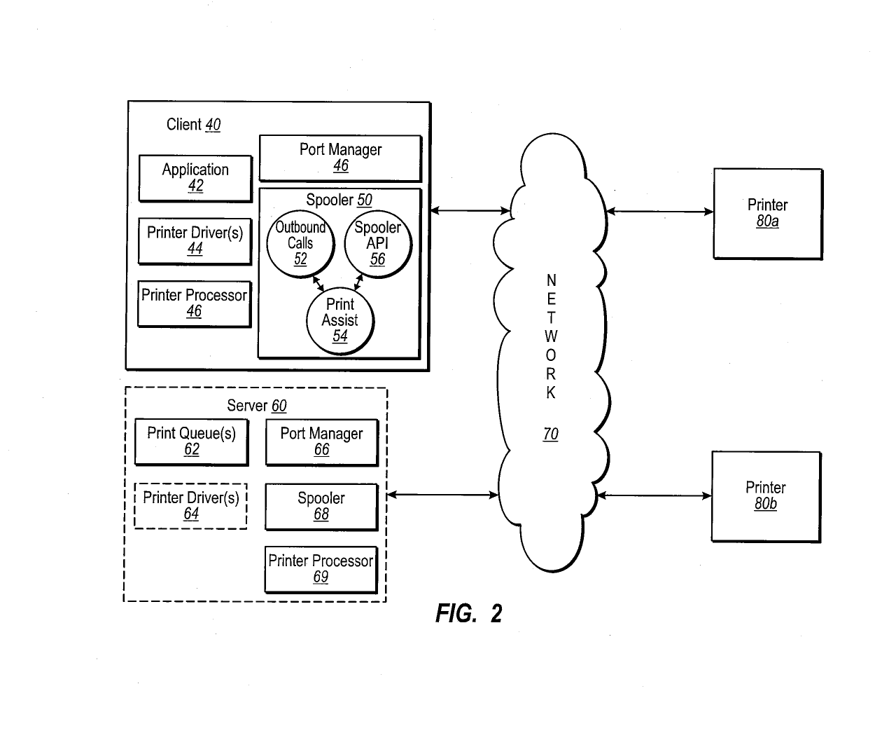

While those skilled in the art will appreciate that the invention may be practiced in networked computing environments with many types of computer system configurations, FIG. 2 represents an embodiment of the present invention in a networked environment that includes clients connected to a server via a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

### Composite Clinical Data Dictionary (C²D²)

In some embodiments of the present invention, which is also referred to as the Composite Clinical Data Dictionary (C²D²) throughout this disclosure, C²D² comprises the set or universe of lowest-level descriptors that may be used to describe any and all data that may make up the most robust and complete computer-based patient record (CPR). This universe includes all clinical data elements required today—and all that will ever be required in the future as the CPR evolves.

Each element or descriptor describes the individual data element that it represents, its attributes and its purpose in being. When used as part of a CPR, the data element leaves absolutely no room for ambiguity.

The component pieces of information being represented have been broken down into their most fundamental “atomic level” or “building block” elements, which must be uniquely identified. This means that any possible data element that may make up a CPR will be described in detail, or that consistent structure will be provided through the C²D² to permit local implementation of items unique to a specific installed CPR system. In some embodiments, the C²D² does not define data values, although in some instances it may define appropriate value ranges.

For example, in some embodiments of the present invention, each patient's CPR will likely contain the name of the patient. Various clinical system implementations will store the patient's name in different ways—many are stored with the last name first, then a comma, then the first name, etc. The present invention permits the complete breakdown and representation of the patient name into its most basic parts. For example, the field PATIENT NAME may have place-holders for sub-fields such as:

last name;

hyphenated last name;

first name;

middle name(s), so that several middle names may be present in the proper order;

numerations, such as John Doe, IV;

other descriptors as needed; and

aliases in order of use.

The present invention contains lowest-level descriptors that are unambiguous, convey meaning, and clearly describe their structure and use. Furthermore, some embodiments of the present invention are sufficiently robust to accommodate other name forms so that any name or combination of names can be used in a CPR. This is necessary because the Western world is accustomed to having last names and first names for individuals. In other parts of the world, different naming and name-order customs are observed and used.

As another example, most people think that the SEX of an individual would be the most straightforward field in the present invention, yet it is not. Many might argue that there are only two, or at most three, possible values for the data itself (e.g., male, female, or unknown). Yet others have proposed that the potential range of values for such a simple data element be as high as nine different values. Various congenital genetic anomalies can and should be accommodated in the C²D². How, for example, does one represent or accommodate the sex of an individual who has had a sex-change operation, or one who has had more than one sex change throughout his or her life? Is SEX a repeating field as described by the C²D² with associated times and dates?

The structure of some embodiments of the present invention is infinitely extensible, accommodating the unforeseen without having to be redesigned. For example, a data element called TEMPERATURE is a repeating field because it can occur many times within a single record or encounter, and it can have several attributes. It also contains several sub-fields that further describe temperature to the fullest extent. (The list of sub-fields for this and every other data element in the C²D² goes on, continually being updated and expanded on an “as-needed” basis. The C² D² is enabled by an architecture and design that permits infinitely expandable capacity for insertion of new fields and sub-fields so as to be able to address every instance of every conceivable new entry over time.)

In some embodiments, the use of modifiers can assist in achieving further accuracy by providing a system for describing highly detailed and systematized information declared in the C² D². For example, the date and time have modifiers associated with them to indicate the particular times and dates addressed by the sub-fields. In this example, the first instance of the time and date may be associated with the READ of the temperature. The modifier clearly provides information about when the temperature reading was taken. In the second instance, the modifier shows when the instrument was calibrated. (The instrument could be calibrated many times; the dates and times of each calibration could be included if desired so that the latest calibration date might be noted.)

In some embodiments of the present invention, the design and architecture is robust enough to accommodate such instances readily and easily. In fact, in such embodiments, the structure is extensible and flexible enough to accommodate each and every instance of any eventuality that may come into existence. For example, in 1960, who could have anticipated the introduction of a CAT scanner? Many new data elements will be introduced over time, and the present invention provides the robust structure to accommodate the unforeseen with ease.

Some embodiments of the present invention accommodate any and all coding schemes, even those not yet introduced. The C²D² does not provide the details of the coding schemes; code developers and their organizations provide those details. The C²D² only points the user to documentation for the various coding schemes. For example, the C²D² is capable of simultaneously including or supporting ICD9-CM, CPT-4, SNOMED-II and SNOMED-III codes, and all other current and future coding schemes. A CPR using data elements described in the C²D² could represent codes from any of these or other coding schemes or, if desired, all of them.

In addition, the present invention supports the National Library of Medicine's Unified Medical Language System (UMLS) program, as well as with other newly developed “dictionaries” such as the MED from Columbia Presbyterian Medical Center and the Voser from IHC. These and most other informatics projects are primarily aimed at resolving significant and complex concepts, terminology and vocabulary issues, or natural language processing issues relevant to clinical data. These and other intriguing efforts have captivated informatics researchers for years, but they are not at all focused on design of a structure to support the description of an exhaustive list (universe) of all of the clinical data elements at the atomic level for all of health care.

A non-limiting example of an implementation of the present invention in a health care environment is as follows:

1) Constructing a C²D² shell or skeleton that can handle atomic-level clinical data elements.

2) Identifying existing clinical data dictionaries in the public and private sectors as the initial sources for populating the C²D².

3) Populating or “fleshing out” some small but important and cohesive set of clinical data elements of the skeleton framework. An example would be filling in the universe of clinical data elements required to support the emergency services record.

4) Testing the full extent of the C²D²'s ability to act as the vehicle for mapping clinical data. Verifying that actual patient records stored in a broad array of clinical information systems (source data systems) can flow to some target system (e.g., a clinical data repository or CDR) using the C²D² as the canonical form.

5) Continuing to further populate the C²D² in a non-redundant way using all available clinical data dictionaries. Demonstrate how any number of CPR systems can use the C²D² to routinely import and export data with only a single translator up, and a single translator down.

6) Encouraging perpetual expansion and maintenance of the C²D² by all organizations.

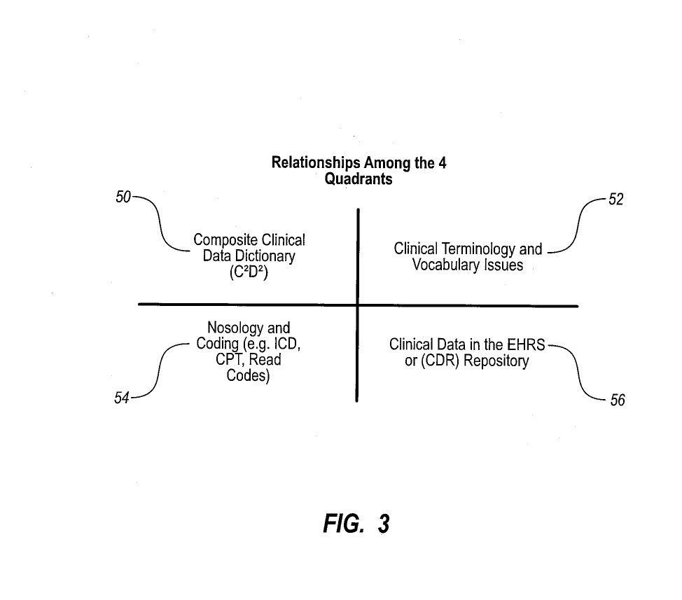

FIG. 3 shows the relationships of four quadrants relevant to the present invention. Composite Clinical Data Dictionary, CCDD or C²D² 50, deals with precise atomic-level data element definitions removing any possibility for ambiguity; it is lots of metadata, in the electronic health records (HER) or CPR. There are four major building blocks that enable the C²D² 50. First, Fields, which each have their specific Indicators and Modifiers. Second, Fields are made up of Sub-field Codes (SFCs) within the Field (each SFC may have its own specific Indicators and Modifiers). Third, Globals, including Global Indicators, and Global Sub-field Codes (G-SFCs), for example G-SFCs are SFCs that are universally applicable and may be associated with any SFC within a Field. Fourth, Groups are established via the Grouping Function (a Group may consist of other Groups and/or any Fields [each Field within the Group may have a specific designated sub-set of SFCs taken from that Field's definition in C2D2] that may be appropriate for inclusion in the Group). The Grouping Function is the way that any collection of data elements such as “Minimal Data Sets” may be specified.

Clinical Terminology quadrant 52 deals with the clinical terms and content of the data stored in the fields described by the CCDD which are used to store data in the CDR. Coding quadrant 54 represents that in healthcare the codes are a shorthand notation for recording observations, diagnoses, procedures, and other aspects of care. Clinical Data 56 is stored within the CDR or a computer-based patient record (CPR or EHR). In some embodiments of the present invention, clinical data 56 is structured to support the full range of diverse individuals who use the data from the CDR/CPR as well as all other applications/uses of the data as desired by the institution.

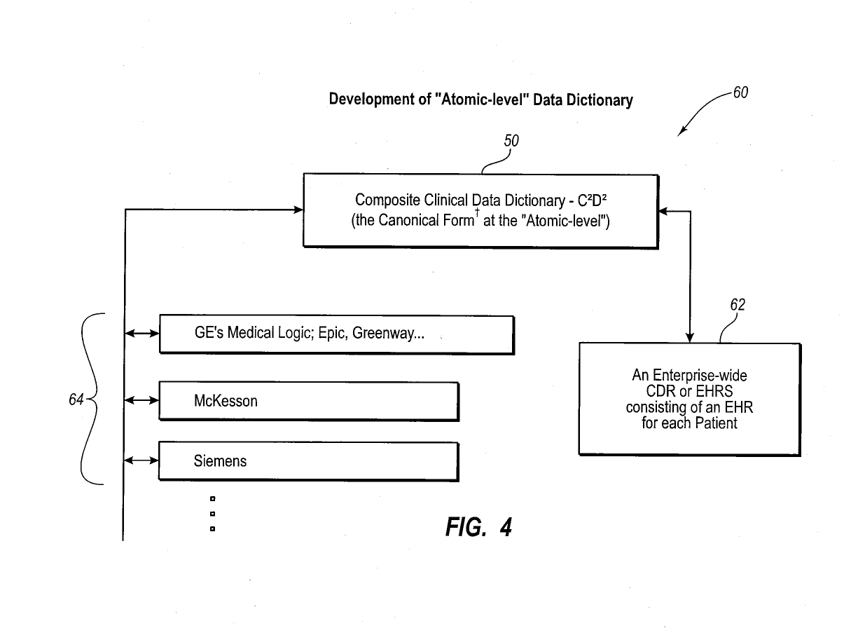

FIG. 4 shows the development of an atomic level data dictionary 60 in some embodiments of the present invention. Creation of enterprise-wide Clinical Data Repository 62 depends on the ability to accurately aggregate data from disparate “feeder systems” 64. This means that the data coming from the various feeder systems 64 must be broken down into distinct atomic-level data elements removing all ambiguity about the data so that the data may then be correctly inserted into the correct data elements within the EHR or the individual record within the CDR. Clinical Terminology 52 and vocabulary tools (e.g. MEDCIN and SNOMED) capable of mapping terms are also used to assist in the normalization of the data before it is inserted into the appropriate named Fields in the “Target System” or enterprise-CDR. With respect to the Data Dictionary 50, most CDR or EHR systems developers confuse this component with the clinical terminology or vocabulary tool set itself, and therefore they pay little attention to the detailed specifications for each of the data element definitions which are important in establishing a robust EHR in the CDR.

Many different clinical terminology tools 52 have emerged in recent years. A non-limiting list of examples includes:
1) Unified Medical Language System (UMLS) from the National Library of Medicine provides links between terms used in clinical information systems with the terms used to search medical literature (e.g., MEDLINE, Cancer Lit. etc.).
2) MEDCIN is a proprietary vocabulary used now in many CPR systems, including Epic.
3) SNOMED's newest version of the clinical terminology developed by the College of American Pathologists (CAP), is probably the most mainstream of the emerging clinical terminology or vocabulary tools and has been adopted by the HHS of the U.S government.
4) The CDR must be able to insert appropriate clinical terminology tools as needed, as well as map between any and perhaps all of them; in recent years two commercial companies have attempted to address these issues: Apelon (formerly LTI) and CyberPlus.

C2D2 50, as shown in the Upper-left Quadrant of FIG. 3, provides all of the “Definitional Details” for each of the “Potential Fields,” and each Field has its own set of “potentially” valuable sub-field codes (SFCs); therefore C2D2 50 is the “Universe” of all of the Potential Fields that may make up a record (this includes any EHR record, any other kind of record [e.g. financial etc.] and is not limited to Clinical data).

The Lower-right Quadrant of FIG. 3, also called the CDR 56, is where the data actually lives (where the data that comprises an EHR resides) and the data and its structure should not be confused with the “Definitional Details” functions that are provided via C2D2 50 in the Upper-left Quadrant. EHR 56, as depicted in the Lower-right Quadrant, utilizes the structures provided by the “Definitional Details” and will consist of a set of Fields, each with its set of SFCs, all of which have been “defined” in great detail within C2D2 50.

Today, most medical informatics professionals are almost totally focused in the upper right quadrant 52, because this is where all the really intellectually stimulating issues are or seem to be—while some others are focused on the lower two quadrants. To use a vocabulary/terminology issue as an example, a group of major health institutions in America performed an analysis of their data and discovered well over 100 different ways to express or say that a patient had hypertension. Given this, it has been readily recognized that it is virtually impossible to select a set of patients who are “hypertensive” or who are suffering from “essential hypertension” and distinguish them one from another. Elaborate and highly complex schemes have therefore been, and are being, conceived to attempt to deal with such “sticky wicket” issues and problems as are observed in the vocabulary quadrant 52.

The lower left quadrant 54 is where the various coding systems such as ICD9, ICD10, READ, and numerous other coding systems, including SNOMED (though SNOMED is a special system which traverses both the vocabulary and the coding quadrants), are found.

Current coding systems are all based upon underlying information which is beyond the scope of their domain. The coding systems do not provide any underlying components that would spell out all of the details required to make a highly precise and differentiated diagnosis. That detail, which is required to make such diagnoses, is found in the atomic level data elements of C2D2 50. In other words, the needed underpinnings for precision in coding, the very precise data elements upon which a diagnosis or an observation or other critical elements of treatment are all established, are covered in the most significant depth and detail within the atomic level data as specified within C2D2 50. The same is true for other types of data, including financial and personal.

C2D2 50 is the bottom of the pyramid and should be the very foundation upon which coding systems rely for making accurate representations of their shorthand notations. The lower right quadrant 56 is where the data is actually stored in a clinical data repository or within an EHR or computer-based patient record. Today, each and every vendor has its own proprietary and unique way of storing the data. This is, of course, a major part of the problem: when you try to transfer data between disparate systems, you find that the data is neither defined nor stored at the atomic level within the individual vendors' systems. That this is not a problem for C2D2 is an advantage of C2D2: to resolve sticky wicket issues in the upper right quadrant 52 and to provide the opportunity for much finer granularity in the lower left quadrant 54 in coding systems.

The lower right quadrant 56 also comes into play in that it enables any vendor or any developer of clinical systems to actually store the data—at the atomic level—in the individual EHR records in their individual repositories.

Coding systems are an attempt at a shorthand notation of recording and categorizing observations, diagnoses, treatments, and other crucial aspects of care. When noting a condition or a diagnosis, or when specifying a diagnosis, it is assumed in each of the coding systems that a criterion upon which that diagnosis or observation is based is included in information that is clear, precise, and available to the individual who determines what exact code is to be assigned. The coder selects a code based on information available to them from the record. This assumes that the information used to make the selection is accurate, complete, and has appropriate precision inherent in it such that the selection between two or more candidate codes can correctly be made.

The emphasis here is probably on both accurate and precise. For example, if those billing coding systems had access to highly granular information, information at the atomic level, then they would be able to be much more precise and accurate in their representation of what the codes actually are. If the granularity of the data were totally at the atomic level, the granularity and precision of the available codes within the coding systems would increase and improve significantly. With better, more precise, accurate information, people can make improved decisions, decisions that are more distinct so that the coder may make appropriate selection of codes. This is to say that the root for solving one of the significant problems in the coding systems is to improve accuracy and precision within the codes. This can only be done through making highly granular data available to those who establish the codes and to those who select the codes in practical use. The route to or foundation of improved coding systems is found in C2D2, which provides atomic-level data definitions which then impact significantly the power of the coding systems that are built and the precision of codes that are selected—thereby supplying those who have the task of coding a given patient encounter highly accurate, highly specific codes and solving for them the primary challenge they currently face.

Since the granularity of the current coding system is not sufficiently explicit or detailed, the coder is faced with the problem of selecting a code for a patient who is neither in the “A” cubby hole nor the “B” cubby hole, but since they are a little more “A” than they are “B,” the coder must put them in the “A” cubby hole. This distorts the reality of a patient's condition.

Thus, coding systems lack the strong, highly granular foundation that would afford coders the precise and accurate information which they need to base their decisions upon. Such precise cubby holes do not exist, nor can they be defined or described adequately because the data supporting hair-splitting details does not exist. That is why C2D2 is such a fundamental foundation piece.

As noted above, the vocabulary quadrant 52 is, today, where most medical informaticists are focused. There appears to be a very strong belief that this is the most crucial and the most daunting task in health care today: to attempt to resolve differences in terminology, in what things are called. However, success in this area is unlikely because the tools needed are lacking.

The objective is to try to use the same terminology and mean with precision exactly the same thing regardless of whether you are a clinician recording a patient observation in Halifax, Nova Scotia, Vienna, Austria, New York City, or San Francisco. That is a tall order, especially when the tools to support precision are woefully lacking. In order to mean the same thing when one uses a certain medical term one must have the fine granularity to answer every conceivable question and every nuance pertaining to a medical concept. This is fundamental and absolutely crucial in order to have an accurate and complete understanding of exactly what a term means, of what parameters feed into making that term exact:

These detailed attributes and parameters to achieve that kind of precision come from the data itself, and if the data itself is not stored at the atomic level, where all ambiguity for every single data element is removed—as is the case with C2D2—then ambiguity is introduced. When there is any ambiguity concerning any of the elements that may be relevant to a vocabulary term, then there is imprecision, there is room for error, and there is room for misinterpretation of exactly what this or that term means. Therefore, once again, the root of solving the sticky wicket issue problems in this upper right quadrant 52 is C2D2. C2D2 is a crucial enabling foundation piece for introducing the highest possible precision, accuracy and hair-splitting definitions in each of the other three quadrants.

In some embodiments, the present invention uses the following basic Field and Sub-field Code structure.

Fields and Subfields

Fields

Indicators
Modifiers

Sub-field Codes (SFC)

Indicators
Modifiers

SFC₁
SFC₂
SFC₃
. . .

In some embodiments of the present invention, Sub-field Codes (SFCs) appear under, and are associated with Fields. SFCs specify all of the details and attributes of atomic-level (lowest-level) data elements for the specific Field that the SFC appears under. As described below, Global Sub-field Codes (G-SFCs) may also be selected and be universally applied as appropriate to any Field within C2D2. For example, Date, Time or Date and Time together; also known as “Date/Time” or “D/T” may be frequently desired and utilized as G-SFCs within many different Fields. Therefore, each of these (“Date,” “Time,” or “Date/Time”), and many more globally-applicable Sub-field Codes would be created and made broadly available so that they may be selected from a library known as the Global Sub-field Code (G-SFCs) Library. This way, rather than having to re-define Date each time a Date may be needed within many different Fields, C²D² provides a means to simply define Date as a G-SFC, then anyone may use a G-SFC wherever it may be appropriate as a SFC for any Field in C²D². Like Groups and Fields, SFCs also have Indicators and Modifiers as tools to further specify details of the SFC.

Standard Sub-field Codes (SFCs) are used under Fields (that is, they are different from Global Sub-field Codes [G-SFCs]) to describe each of the data elements under the Field. Most SFCs are coded as a single alphabetic character code as described below: Standard Sub-field Codes (SFCs) may be structured as described in the following non-limiting example:
Standard Sub-field codes start with a single capital letter from the letter “A” to the letter “Z” (A-Z) then, if there are more than 26 Sub-field Codes within a Field, then the next, or 27th Sub-field Code would start with “AA” continuing thru “AZ” and then “BA” continuing thru “BZ” . . . , then “AAA” thru “AAZ” etc., thus permitting unlimited growth of SFCs under a single Field. However, if one should find a Field that has more than 26 (A-Z) different Sub-field Codes within a single Field, then you probably are not yet able to get down to the atomic-level and should therefore probably consider breaking this Field up into additional Fields. By so doing one can break the most essential data elements apart at the Field level, before dealing with assigning so many Sub-field Codes to a single Field. Each Sub-field Code (e.g. such as the Sub-field Code: K or N, would be mapped with its 64 character coded name, and the full and lengthy description which is totally variable length) can be interpreted or described in detail through additional table look-ups.
   Besides the Indicators and Modifiers associated with a SFC, note that there are several associated Tables which provide considerable detail about each SFC:

Attribute Table

Data Types Table

Data Format/Structure Table

Data Sizing Table

Acceptable Ranges of Values Table

Sets of Values Table

Check Digit/Validity/Verification Algorithms Table

Validity Checks with other Fields Table

Validity Checks with other Sub-field Codes (SFC) Table

Validity Checks with other Global Sub-field Codes (G-SFC) Table

Translation Tables Table

Rule Sets or Algorithms for Parsing Table

In addition, in some embodiments of the present invention, All Fields and Sub-field Codes (SFCs) in C2D2 may have Indicators which are designed to convey additional information specific to the Field or SFC that the Indicator is tied to. For the purposes of this discussion, what is said here about Indicators pertaining to SFCs, could also be generally applied to Indicators for Fields. Indicators are specific to a given SFC, and are there to further clarify, and provide a means of proper interpretation of the meaning of a SFC.

In some embodiments of the present invention, it is possible to have both Indicators that are specific to a SFC, as well as Global Indicators which together provide a means of specificity interpreting the real meaning and accuracy of the data described in the SFC. Global Indicators are distinguished from normal Indicators appearing in either Fields or SFCs, by the fact that they start with an alpha-character like those seen below. Like G-SFCs, the Global Indicators (G-Ind), are made available from a library so that they may be selected from a library known as the Global Indicator or (G-Ind) Library. The Global Indicator Library is further sub-divided into different categories of Indicators within the Library.

In some embodiments of the present invention, the following general rules should typically be followed:
1. If a Field is specified as a Repeating Field [via an Indicator] meaning that it is or may be used over and over within a record, then generally speaking and by default NONE of the SFCs within such a Repeating Field may be defined as a Repeating SFC.
2. No Field should be deleted from C²D², to do otherwise would make it so that “Old Data” could never be interpreted at all, or interpreted at all correctly.
3. No Sub-field Code should be deleted from a Field within C²D², to do otherwise would make it so that “Old Data” could never be interpreted at all, or at all correctly.
4. If a Field should grow to have more than 26 SFCs (that is, you have exhausted the A-Z single-character sequence, and have now started into the AA-AZ, or two-character sequence) [note that this does not include G-SFCs] under it, then you are probably better off to find a way to further sub-divide this Field. By doing so one can place the parts or pieces of the Field into smaller, more manageable chunks of data that should themselves become new Fields. So, though the SFCs structure will actually permit you continue to add innumerable SFCs under a Field, the practicality of doing so is suspect and a questionable practice.

The following is a detailed example of how Fields and SFCs may be described within some embodiments of the present invention.

For Each of the Fields as defined within C²D²:

Field Name:
Field Indicators:
Field Modifiers:
Names of Additional Tables describing in detail this Field:
   Attribute Table
   Data Types Table
   Data Format/Structure Table
   Data Sizing Table
   Acceptable Ranges of Values Table
   Sets of Values Table
   Check Digit/Validity/Verification Algorithms Table
   Validity Checks with other Fields Table
   Validity Checks with other Sub-field Codes (SFC) Table
   Validity Checks with other Global Sub-field Codes (G-SFC) Table
   Translation Tables Table
   Rule Sets or Algorithms for Parsing Table
   . . .

Sub-field Codes (SFCs) each with their Indicators and Modifiers:
1st SFC:
   SFC Name:
   SFC Indicators:
   SFC Modifiers:
   Names of Additional Tables describing in detail this SFC:
      Attribute Table
      Data Types Table
      Data Format/Structure Table
      Data Sizing Table
      Acceptable Ranges of Values Table
      Sets of Values Table
      Check Digit/Validity/Verification Algorithms Table
      Validity Checks with other Fields Table
      Validity Checks with other Sub-field Codes (SFC) Table
      Validity Checks with other Global Sub-field Codes (G-SFC)
      Table
      Translation Tables Table
      Rule Sets or Algorithms for Parsing Table
      . . .
2^{nd} SFC:
   SFC Name:
   SFC Indicators:
   SFC Modifiers:
   Names of Additional Tables describing in detail this SFC:
      Attribute Table
      Data Types Table
      Data Format/Structure Table
      Data Sizing Table
      Acceptable Ranges of Values Table
      Sets of Values Table
      Check Digit/Validity/Verification Algorithms Table
      Validity Checks with other Fields Table
      Validity Checks with other Sub-field Codes (SFC) Table
      Validity Checks with other Global Sub-field Codes (G-SFC)
      Table
      Translation Tables Table
      Rule Sets or Algorithms for Parsing Table
      . . .
3^{rd} SFC etc.
   SFC Name:
   SFC Indicators:
   SFC Modifiers:
   Names of Additional Tables describing in detail this SFC:
      Attribute Table
      Data Types Table
      Data Format/Structure Table
      Data Sizing Table
      Acceptable Ranges of Values Table
      Sets of Values Table
      Check Digit/Validity/Verification Algorithms Table
      Validity Checks with other Fields Table
      Validity Checks with other Sub-field Codes (SFC) Table
      Validity Checks with other Global Sub-field Codes (G-SFC)
      Table
      Translation Tables Table
      Rule Sets or Algorithms for Parsing Table
      . . .
4^{th} SFC and on and on with additional SFCs as they may become necessary to add over time—note that we do not have to provide all of the Fields, nor do we have to provide all of the SFCs for any given Field upfront, they will be added as we encounter them or as we need them.

Additional Global Sub-field Codes may be included as necessary.

The following is a non-limiting example of how sub-field codes and their data are defined in some embodiments of the present invention:

Descriptions of Additional Tables that describe in detail SFCs:

Attribute Table

Data Types Table

Data Format/Structure Table

Data Sizing Table

Acceptable Ranges of Values Table

Sets of Values Table

Check Digit/Validity/Verification Algorithms Table

Validity Checks with other Fields Table

Validity Checks with other Sub-field Codes (SFC) Table

Validity Checks with other Global Sub-field Codes (G-SFC) Table

Translation Tables Table

Rule Sets or Algorithms for Parsing Table

. . .

Details specifying the contents of each of these Additional Tables:

ATTRIBUTE TABLE

| | |
|---|---|
| Is this SFC a Required element | Yes/No (0/1) |
| Is this a Repeating SFC | Yes/No (0/1) |
| Upper-bound on Limit of | N is maximum number of Repeating |
| Occurrences: | Occurrences |
| Lower-bound on Limit of | (a number ≦N, or the upper-bound) |
| Occurrences | |

(NOTE: any Minimum or a required specific number of occurrences may be established via Upper-bound and Lower-bound entries in this Attributes Table)
Encrypted
N = Never,
A = Always,
V = Varies

DATA TYPES TABLE

| | |
|---|---|
| A - Alphabetic Character[s] | Yes/No (0/1) |
| N - Numeric Character[s] | Yes/No (0/1) |
| A/N - Alpha-Numeric Character[s] | Yes/No (0/1) |
| R - Roman Numerals | Yes/No (0/1) |
| C - Combination of Types | Types (e.g. A + R for John |
| | Sakrolovsky III) |
| B - Bit Strings (e.g. BLOBS) | Yes/No (0/1) |
| . . . | |

DATA FORMAT/STRUCTURE TABLE

| | |
|---|---|
| Most common format for this SFC | NNN “-”NN “-”NNNN |
| | (e.g. 538-27-6701) |
| Format for Alternative-1 | |
| Format for Alternative-2 | |
| Format for Alternative-3 | |
| . . . | |

DATA SIZING TABLE

| | |
|---|---|
| Totally Variable Length (unlimited) | Yes/No (0/1) |
| Partially Variable Length (within a range UB-LB) | Yes/No (0/1) |
| Lengths are specified as Bytes or bits | B = Bytes, b = bits |
| Set Length | N Bytes/bits long |
| Upper-bound on Total Length Limit: | N is maximum Total |
| | Length |
| Lower-bound on Total Length Limit | (a number ≦N, or |
| | the upper-bound) |

(NOTE: any Minimum or a required specific number for Total
Length may be established via Upper-bound and Lower-bound Total
Length entries here)

| | |
|---|---|
| Blocking of the Data into chunks is permitted | Yes/No (0/1) |
| Upper-bound on Block Length Limit: | N is maximum Block |
| | Length |
| Lower-bound on Block Length Limit | (a number ≦N, or |
| | the upper-bound) |

(NOTE: any Minimum or a required specific number for Block
Length may be established via Upper-bound and Lower-bound Block
Length entries here)
. . .

ACCEPTABLE RANGES OF VALUES TABLE

| | |
|---|---|
| There is a Range, or there is a Designated Specific | R/V |
| Value | |
| Multiple-values - as specified in the Sets of Values | Yes/No (0/1) |
| Table | |
| (If V, then the Only Acceptable Specific Value is: | <VALUE> |
| Range is expressed as an Alphabetic range | Yes/No (0/1) |
| Range is expressed as a Numeric range | Yes/No (0/1) |
| Range is expressed as a Alpha-Numeric range | Yes/No (0/1) |
| Lower-bound on Limit or Value | (If numeric then a number |
| | ≦N, as specified in the upper-bound for the Limit or Value) [e.g. for a Range 5 to 9 |
| | then this Lower-bound will be equal to 5; for alpha-ranges such as for Last Name a |
| | value of the Lower-bound might be expressed as “C*” meaning all Last Names that |
| | start with letter C, or another example might be “Ce*” = Last Names starting with the |
| | sequence of letters: “Ce”] |
| Upper-bound on Value Limit: | (If numeric then N is |
| | maximum or Upper-bound Limit for a Value) [e.g. continuing the same example as |
| | above, the Upper-bound Limit will be equal to 9; for alpha-ranges such as Last Name |
| | a Last Name starting with the letter K, K* = all Last names starting with the letter K, |
| | or Ki* = Last names starting with Ki - Note in this example with a Lower-bound and |
| | an Upper-bound so specified it would fill all names starting with the letter C through |
| | all names that start with Ki . . . ] |

(NOTE: any Minimum or a required specific number for Total Length may be established via Upper-bound and Lower-bound Total Length entries here)

SETS OF VALUES TABLE

| | |
|---|---|
| Set containing Default/Usual/Expected Values | Set-Name-1 |
| Set containing 2^{nd} Most Usual Values | Set-Name-2 |
| Set containing 3^{rd} Most Usual Values | Set-Name-3 |
| Alternative Set₁ containing another set of Values | A-Set-Name-1 |
| Alternative Set₂ containing another set of Values | A-Set-Name-2 |
| Alternative Set₃ containing another set of Values | A-Set-Name-3 |
| . . . | |

CHECK DIGIT/VALIDITY/VERIFICATION ALGORITHMS TABLE

| | |
|---|---|
| Cyclic Redundancy Check (CRC) Algorithm | Algo-CRC-1 |
| Check Digit Routine (Code-39) Algorithm | Algo-CD-Code39 |
| . . . | |

TRANSLATION TABLES TABLE

| | |
|---|---|
| Table containing Default/Usual/Expected Translation of | T-Table-1 |
| Values | |
| Table containing 2^{nd} Most Usual Translation of Values | T-Table-2 |
| Table containing 3^{rd} Most Usual Translation of Values | T-Table-3 |
| Alternative Table₁ containing another set of Translation | A-T-Table-1 |
| Values | |
| Alternative Table₂ containing another set of Translation | A-T-Table-2 |
| Values | |
| Alternative Table₃ containing another set of Translation | A-T-Table-3 |
| Values | |

Some embodiments of the present invention include grouping. In these embodiments, any desired “Minimum Data Set” as a new Group can be created by anyone via the Groupings function provided within C²D². A Group may include and consist of two or more existing Groups defined within C²D², which together will now compose a new Group. Via the Groupings function provided within C²D² one may designate a new Group by identifying one or more existing Groups, and then extend it further by adding a set of specific additional Fields that together will compose a new Group.

This mechanism of establishing Groups consisting of other Groups will enable us to specify major or minor sections of the record via the Groupings function provided within C²D². (e.g. The demographics section of the EHR record is accomplished via this mechanism, the financials section[s] of the record and all other sections may be established in this way as well).

There will be a core set of Groups, and Fields, that together compose what would become known as “The Core C²D²” (this is the center or hub of the flower analogy) and this too will also be established and defined via the Groupings function, and this Group will become the Root or The Core Grouping which will be used widely.

Political and cultural boundaries are a reality that must be dealt with in C²D². Therefore, Nations, Regions and more localized areas (Provinces, States etc.) will have the need to establish and set their own extensions to The Core C²D² and this need will be addressed via the Groupings function provided within C²D².

Any medical Specialty Society, or any Sub-specialty Society will find that their unique needs can and will be met via the Groupings function provided within C²D². Furthermore, any types of Relationship between and among Groups may also be established and described using the Groupings function provided within C²D². The Groupings function also supports the ability to have Groups specified externally (by anyone needing to set up Groups of Fields and SFCs). Externally specified Groups shall be stored within the following Grouping Libraries, the standard categories of Groupings Libraries shall consist of:
1. The Core C²D² and all Officially Internationally-recognized appendages to The Core C²D²; note that The Core C²D² is labeled as such, and all other Groups within this category begin with the “!” thus distinguishing them as being within the “Global” set.
2. Aspiring but Not yet Officially Internationally-recognized Groupings
3. Officially-recognized Groupings for areas, regions or large organizations
4. Aspiring but Not yet Officially-recognized Groupings for areas, regions or large organizations
5. Officially-recognized Groupings for more localized regions (states, counties, cities or more moderate size organizations)
6. Aspiring but Not yet Officially-recognized Groupings for more localized regions (states, counties, cities or more moderate size organizations)
7. Groupings that have been made publicly available like Shareware and all Groups within this category begin with the “?” thus distinguishing them as being within the “Shareware” category of Groupings.
8. Any Group created via the Grouping function that has been created by an individual may be viewed as strictly “Local.” Therefore, “Local” Groups will utilize two question marks as the initial two-characters of the name of the Group thus distinguishing it as Local and not for general use. For example the name: “??-My Minimum Data Set for My Study” might be the name of a Local Group important to me and used by me as an individual.

All Groups are established and specified by first selecting Groups (if any are desired by selecting the Group[s] from among the existing Groups), then by selecting any Fields (any Fields, with their Indicators and Modifiers that are to be specifically included that are in addition to the those as specified in the selected Group[s]), and finally, by selecting only the specific Sub-field codes (SFCs and G-SFCs), Indicators and Modifiers for each of the specified Fields. The Groupings function provided within C²D² provides the means of viewing Groups from a variety of perspectives (e.g. show me all Groups that have certain sets of Fields or that have specific Groups). Note that Groups may also have Indicators and Modifiers used in a manner similar to those applied to Fields and Sub-field Codes.

One of the most powerful attributes of Groups is that via the Grouping function within C²D² owners/builders of a Group may copy all of the attribute tables for a specific Field or any of its SFCs (NOT G-SFCs or Global Indicators) and make their own alterations as they may find necessary to meet their particular needs. However if they should make any changes whatsoever to these powerful and important Tables, then those revised Tables for any of the changed Fields and SFCs within this Group will be automatically published (e.g. via XSRs) to any potential user of data associated with the Group that made the changes. These are very important and extremely powerful tools that permit local tailoring of the data to meet local needs. Yet at the same time, it also informs any prospective user concerning all of the details concerning exactly how these data or structures for the data may vary from the Standard definitions as seen in The Core C²D² or from the Group that initially defined and established the Field or SFCs.

The following example may prove helpful in understanding how the Grouping function within C²D² may be used to create important Groups of Fields for any worthwhile purpose, and by anyone.

Key elements describing, as well as serving as input parameters into the Grouping Function for forming a new Group are as follows:

Group Name: Birthing - Minimal Data Set
Sponsor/Developer: ACOG [American College of Obstetrics
and Gynecology]
Purpose:
Limitations/Restrictions on Use:
Limitations/Restrictions on Distribution:
Number of Downloads:
Contact: james.rush@acog.org
Date of Creation:
Date of last Update:
Frequency of Scheduled Updates:
Other Groups that have been included within this Group:
1. Risk Factors - Birthing;
2. Pre-natal - Minimal Data Set;
3. . . .

Required Fields within Each of the Other Groups that MUST be included:

| | Field Code Name | SFCs to be Included |
|---|---|---|
| 1. | LABC-16; | SFCs Included: <B;D;!D/T-17′;K;> |
| 2. | DRBN-3; | |
| 3. | . . . | |

Required Fields with their SFCs that are to be included:

| | Field Code Name | SFCs to be Included |
|---|---|---|
| 4. | ABC-10; | SFCs Included: <A;C;!D/T-427′;F;H> † |
| 5. | DGJ-3; | |
| 6. | . . . | |

Additional Optional Fields with their SFCs that are to be included:

| Field Code Name | SFCs to be Included |
|---|---|
| 7. ALM-8; | SFCs Included: <B;C;!Date-37′;F;P> |
| 8. DGJ-3; | |
| 9. . . . | |

† Interpreted, this means that for the Field that has as it's code name: “ABC-10”, the following SFCs for that Field will be INCLUDED within this Group called the Birthing—Minimal Data Set.:

| SFCs and the Global-SFC | G-SFCs |
|---|---|
| A | !D/T-427 |
| C | |
| F | |
| H | |

The Grouping Function present in some embodiments of C²D² enables the creation of logically-associated sets or Groups of Fields. Groups may be created by selecting specific individual Fields, and a Group may also include one or more pre-established Groups. Individual Fields may vary one from another by simply the addition of a Modifier at the Field level or at the SFC level (e.g. how the Veterans Administration or VA interprets certain ICD codes under certain circumstances is one such example). As far as removing all ambiguity is concerned for data, C²D² is uniquely powerful, there is no situation, no circumstance, no matter how obscure, no matter how convoluted, no matter how complex, that C²D² cannot deal with effectively—and with ease.

The Complete Blood Count, or CBC, is a good example for illustrating this. For example, consider the following proposed structure for the different Groups that deal with the common lab test known as CBC in different ways.

Assume that the following Groups (Groups have Names) have been established:

A. WBC-All

B. WBC-Diffs (differentials)

C. RBC-All

D. RBC-Indices

E. CBC-CAP-U.S.—Standard

F. CBC-CAP-Canadian—Standard

G. CBC-IHC-Northern Utah—Standard (this is IHC's—Utah's own view of a CBC)

H. CBC-IHC-Southern Utah—Standard (this is IHC's—Utah's own view of a CBC)

I. CHEM7-CAP-U.S.—Standard

Therefore the Groups listed seen below may consist of the both existing Groups, as well as individual tests as indicated below:

A. Group Name: WBC-All:
1. Established Groups that are included within this Group:
   WBC Diffs
2. Individual Tests (Fields within C²D²) that are included in this Group:
   WBC-Count

B. Group Name: WBC-Diffs
1. Established Groups that are included within this Group:
   <None>
2. Individual Tests (Fields within C²D²) that are included in this Group:
   a. Neutrophils-[PMNs]
   b. Neutrophils-[BAND]
   c. Lymphocytes
   d. Monocytes
   e. Eosinophils
   f. Basophils

C. Group Name: RBC-All:
1. Established Groups that are included within this Group:
   a. RBC-Indices
2. Individual Tests (Fields within C²D²) that are included in this Group:
   a. RBC-Count
   b. Hematocrit-HCT or PCV
   c. Hemoglobin (Hgb)
   d. Platelet (Thrombocyte)-Count
   e. Red Cell Distribution and Width (RDW)

D. Group Name: RBC-Indices:
1. Established Groups that are included within this Group:
   <none>
2. Individual Tests (Fields within C²D²) that are included in this Group:
   a. Mean Corpuscular Volume (MCV)
   b. Mean Corpuscular Hemoglobin (MCH)
   c. Mean Corpuscular Hemoglobin Concentration (MCHC)

E. Group Name: CBC-CAP-U.S.—Standard
1. Established Groups that are included within this Group:
   a. RBC-All
   b. WBC-All
2. Individual Tests (Fields within C²D²) that are included in this Group:
   a. Blood-Smear (Peripheral Smear)

F. Group Name: CBC-CAP-Canadian—Standard
<Example to be filled in later>

G. Group Name: CBC-IHC-Northern Utah-Standard
1. Established Groups that are included within this Group:
   a. WBC-All
2. Individual Tests (Fields within C²D²) that are included in this Group:
   a. RBC-Count
   b. Hematocrit-HCT or PCV
   c. Hemoglobin (Hgb)
   d. Platelet (Thrombocyte)-Count

H. Group Name: CBC-IHC-Southern Utah-Standard
1. Established Groups that are included within this Group:
   a. WBC-All
2. Individual Tests (Fields within C²D²) that are included in this Group:
   a. RBC-Count
   b. Hematocrit-HCT or PCV
   c. Hemoglobin (Hgb)
   d. Platelet (Thrombocyte)-Count
   e. Blood-Smear (Peripheral Smear)

I. Group Name: CHEM7-CAP-U.S.—Standard
1. Established Groups that are included within this Group:
   <none>
2. Individual Tests (Fields within C²D²) that are included in this Group:
   a. Blood Urea Nitrogen (BUN)
   b. Serum Chloride (CI—)
   c. Bicarbonate (CO2 or HCO3-)
   d. Creatinine
   e. Glucose (FBS)
   f. Serum Potassium (K+)
   g. Serum Sodium (NA+)

This is a non-limiting example used in some embodiments of the present invention of the Global Sub-Field (G-SFC) called “G_Postal_Code_X” and all of the descriptions for all of the Indicators that address “G_Postal_Code_X.” This is provided only as an example to convey basic concepts concerning the structure used for specifying all of the currently-conceived Indicators for this G-SFC. Note also that this Global Sub-Field Code, “G_Postal_Code_X” though it is usually applied to an address via the “Place” Field, it can also be applied to any Field or SFC within any Field, which enables one to associate a general location (e.g. in the U.S.A., an area designated as a Zip Code) with any Field or SFC within a Field because “G_Postal_Code_X” is a G-SFC. For example, this G-SFC could be applied to or used in conjunction with a Field: “Telephone-number.” The phone number may turn out to be a public telephone, or even the current general location of a Cell phone and this would enable one to know the general location, but not likely the precise location of that public phone or Cell phone.

Global Sub-Field Code: G_Postal_Code_X

| Indicators | | |
|---|---|---|
| 0 | X^{∂} is the n^{th} Instance of a different Country and Format for Postal- | |
| | Code (where the value of X has no upper-bound and may approach ∞. | |
| | NOTE: This structure enables not only the use of any number of | |
| | Postal-Code formats, for any Country anywhere around the world. It is | |
| | also sufficiently flexible so that it will support any number of Postal- | |
| | Code formats within any single country. For example, the UK utilizes | |
| | at least 9 different Postal-Code formats.) | |
| 1 | Repeating | 1 |
| 2 | Language (ISO 639.2) | [List is Maintained by LoC] |
| | http://www.loc.gov/standards/iso639-2/langcodes.html#cd | |
| | ttp://www.loc.gov/standards/ | |
| 3 | Country Code 2-Alphas-ISO-3166 | GB |
| 4 | Country Code 3-Alphas-ISO-3166 | GBR |
| 5 | Country Code-Number-ISO-3166 | 826 |
| 6 | Country Name Great Britain, United States of America | |
| 7 | Assigning Postal Authority | U.S. Postmaster General |
| 8 | PostalCode Format & String Value | NNNNN-:NNNN Val. = 12345-6789 |
| 9 | State/Province/Div. of County Name | Massachusetts, Quebec |
| 10 | Level # for Next-level Div. Name | 3 |
| 11 | Name of the “Next-level” item | County |
| 12 | Official Name of “Next-level” entity | Middlesex |
| | NOTE: Use Indicators 10 through 12 repeatedly for showing any | |
| | number of levels below the Country (in U.S.: State, County, City, etc.) | |
| | to show what levels are being used within the Postal Codes | |
| 13 | Total Number of Segments | 2 |
| 14 | Segment # | 1 or 2 |
| 15 | Identity of Segment # | 1\|1^{st} Segment = 1^{st} 5 digits of Zip Code |
| 16 | Type of Content of Segment # | Numeric-Digits |
| 17 | Length of Segment # | 1\|5 |
| 18 | Pad with Leading Zeros Required | Y/N so full length requirement is |
| | | met) |
| 19 | Value of Segment # | 23456 (meeting Format |
| | | requirements) |
| 20 | Delimiter after Segment # | 1\|-[Note: Inds. 14-20 repeats 2 |
| | | times] |
| 21 | Name of the Postal Code | Zip Code |

NOTE: Use Indicators 14 through 20 repeatedly (up to N times, where
N is the Total Number of Segments within this Postal_Code_X, as
specified in Indicator 12) for showing the details of the Postal-Code
segmentation structure and this enables specification of the full details
for each segment within this Postal_Code_X.

Modifiers:
1 Any special additional information that may modify aspects of the Postal_Code_X.

Note that in practical usage of the G-SFC G_Postal_Code, that when storing a date in a record (LRQ e.g. within a EMR stored in a CDR), that we need only utilize and store the contents of Indicator 8 which is the “Postal Code Format & String Value” for the G_Postal_Code_X. All other detailed relevant data (see Indicators 1-7, and 9-21 above) pertaining to the G-SFC: G_Postal_Code may be seen in the full description of G_Postal_Code as seen in the above material.

Global Sub-Field Code (G-SFC)—Short-form Examples for G_Postal_Code_X:

G-SFC: Three simple examples of the G-SFC: G_Postal_Code

[NOTE: Indicator 8 or IND-8, holds the primary information needed for the storage of this “Postal-Code” in most data repositories. Indicator 8 supplies both the Format of G_Postal_Code_{—}247 as well as the Value for G_Postal_Code_{—}247.]

| | | FORMAT | |
|---|---|---|---|
| G-SFC: | IND. | DESCRIPTION | VAL. EXAMPLE |
| G_Postal_Code_247 | 8 | NNNNN-NNNN | 94332-1998 |
| G_Postal_Code_38 | 8 | A9A 9A9 | H6L 8K4 |
| G_Postal_Code_248 | 8 | NNNNN | 84107 |

In most instances the “Short-form” version of G_Postal_Code, will be adequate for storing dates within any record in the lower-right-quadrant (LRQ). However, there may be some instances in which it would be advantageous or necessary to store the complete details of a G_Postal_Code, or Long-form” version of a G_Postal_Code and the following examples illustrate what such a complete G-SFC would look like if that option were pursued.

Global Sub-Field Code (G-SFC)—Long-form Examples for G_Postal_Code:

G-SFC: G_Postal_Code_{—}247

| IND. | VALUE & DESCRIPTION | EXAMPLE |
|---|---|---|
| 0 | 247, meaning 247^{th} instance of G_Postal_Code | 247 |
| 1 | Repeating G-SFC 1 = this can Repeat | 1 |
| 2 | Language of the G-SFC | eng |
| 3 | Country Code 2-Alphas-ISO-3166 | US |
| 4 | Country Code 3-Alphas-ISO-3166 | USA |
| 5 | Country Code-Number-ISO-3166 | 840 |
| 6 | Country Name | United States of America |
| 7 | Assigning Postal Authority | U.S. Postmaster General |
| 8 | Postal Code Format & String Value | NNNNN-NNNN Val. = 02215-2393 |
| 9 | State/Province/Div. of County Name | Massachusetts |
| 10 | Level # for Next-level Div. Name | 3 |
| 11 | Name of the “Next-level” item | County |
| 12 | Name of the “Next-level” entity | Middlesex |
| 13 | Total Number of Segments | 2 |
| 14 | Segment # | 1 |
| 15 | Identity of Segment # | 1\|1^{st} 5 digits of Zip Code |
| 16 | Type of Content of Segment # | 1\|Numeric-Digits |
| 17 | Length of Segment # | 1\|5 |
| 18 | Pad with Leading Zeros Required | 1\|Y |
| 19 | Value of Segment # | 1\|02215 |
| 20 | Delimiter after Segment # | 1\|— |
| 14 | Segment # | 2 |
| 15 | Identity of Segment # | 2\|2nd Segment, last 4 digits of |
| | | Zip Code |
| 16 | Type of Content of Segment # | 2\|Numeric-Digits |
| 17 | Length of Segment # | 2\|4 |
| 18 | Pad with Leading Zeros Required | 2\|N |
| 19 | Value of Segment # | 2\|2393 |
| 20 | Delimiter after Segment # | 2\|<None> |
| 21 | Name of the Postal Code | Zip Code |
| [NOTE: Indicator 8 or IND-8, holds the primary information needed for the storage of this “Postal-Code” in most data repositories. Indicator 8 supplies both the Format of G_Postal_Code_247 as well as the Value for | | |
| # G_Postal_Code_247. Also Note that Indicators 14-20 are repeated two times, and thus the repetition of this sequence of Indicators conveys the complete details of the contents of each of the two Segments that make up the composition of G_Postal_Code_247] | | |

Also called postcodes or ZIP codes, postal codes are assigned by postal authorities in many (but not all) countries to enable them to identify more efficiently the delivery point of the address on the envelope. The format and coverage of each postal code differs between and within countries.

In some countries, such as the United Kingdom and The Netherlands, each code covers a consistent number of delivery points. In other countries, like Germany, Sweden, France and Italy, a single postal code can refer to a single large company, a set of postboxes, a set of buildings, an area of streets, a whole village or several villages. In other countries, such as Belgium, the area covered by a postal code is never smaller than a municipality.

Some countries, such as Ireland, have no postal code system. In any case, where available, it is important to use the correct postal code, in the correct format and in the correct place in the address block to ensure delivery of your item.

Like address blocks, the format of postal codes differs between countries, and also sometimes within countries. In Australia, Austria, Belgium, Denmark and New Zealand, for example, the format is 4 digits. In France, Germany and Italy it is 5 digits. In Greece and Sweden this is also the case, but there is a space between the third and fourth digits. In Singapore the postal codes have 6 digits. In Canada the format is A9A 9A9. In The Netherlands it is 9999 AA. In the United Kingdom the postal code can have 7 different formats, and in The United States, a ZIP code can be 5 digits long or 9 digits long with a hyphen between the fifth and sixth digits.

This is a realistic example found in some embodiments of the present invention of the DATA Representations for a married Hispanic woman, which utilizes only a few of the data element structures (e.g., including multiple first names and maternal and husband's last name as an example) extracted from all of the many potential data elements for Personal_Name in C²D². This is an example of the actual use of the Field: Personal_Name and SFC descriptions for “Personal Name” and how it would be used to represent a married Hispanic woman which presents an interesting set of changes to the way most Americans might look at a personal name. This example shows how this rather complex situation can be fully represented via the constructs inherent within C²D².

Field: Personal_Name
Indicators:

| Ind | SHORT | LONG/DESCRIPTION | Actual Data |
|---|---|---|---|
| 0 | CC | Composite Current | CC |
| 1 | REPEAT | Repeating is permitted | 1 |
| 2 | LANG | Language Code (ISO 639-2) | spa |

Modifiers:
Sub-Field Codes (SFCs):

| SFC | SHORT | LONG/DESCRIPTION | Actual Data |
|---|---|---|---|
| B | LN | Last Name or Family Name | Muñoz |
| D | FN | First or Given Name | |
| | | Indicators: | |
| | | 1 Repeating SFC | 1 |
| | | 2 Sequence | 1 (n = the order of the First Name) |
| | | 3 Value | Rosa |
| | | Modifiers: | |
| D | FN | First or Given Name | |
| | | Indicators: | |
| | | 1 Repeating SFC | 1 |
| | | 2 Sequence | 2 (n = the order of the First Name) |
| | | 3 Value | María |
| | | Modifiers: | |

G_Date_237 Ind: 6|Date = DD:MM:YYYY format 6|17:01:1962

Global Indicators for G-SFC “G_Date_237” are:

| E | Event Indicator: 1 = Birth | | E1 |
|---|---|---|---|
| | Modifiers for G-SFC “G_Date_237” are: | | |
| | <None> | | |
| H | SUF2 | LN-Academic Suffixes | |
| | | Indicators: | |
| | | 1 Repeating SFC | 1 |
| | | 2 Sequence | 1 |
| | | 3 Value | Ph.D. |
| | | Modifiers: | |
| Q | CP-MN | Current-Previous Married Name | |
| | | Indicators: | |
| | | 0 Composite Current | 1 = yes, this is current Married Name |
| | | 1 Repeating SFC | 1 = yes, this is repeating |
| | | 2 Sequence | 1 Order/Sequence of C-P Married Name |
| | | 3 Value | Gómez |
| | | Modifiers: | |
| R | MLN | Maternal Last Name | Izquierdo |
| S | PLN | Paternal Last Name | Muñoz |
| Z | D-NAM | Display/Print Name | |
| | | Indicators: | |
| | | 1 Repeating SFC | 1 |
| | | 2 Sequence | 1 (n = the order of the Name) |
| | | 3 SFC Specification/Sequence | 1\|D1\|D2\|B\|R\|Q1\|H1 [D1 = 1^{st} First Name, |
| | | | D2 = 2^{nd} First Name, B = Last |
| | | | Name, R = Maternal Last, |
| | | | Q1 = 1^{st} & Current Married Last Name, H1 = 1^{st} |
| | | | Academic Suffix] |
| | | 4 D-NAM Value | 1\|Rosa María Muñoz Izquierdo de |
| | | | Gómez, Ph.D. |
| | | Modifiers: | |
| Z | D-NAM | Display/Print Name | |
| | | Indicators: | |
| | | 1 Repeating SFC | 1 |
| | | 2 Sequence | 2 (n = the order of the Name) |
| | | 3 SFC Specification/Sequence | 2\|D1\|D2\|B\|Q1 [D1 = 1^{st} First Name, |
| | | | D2 = 2^{nd} First Name, B = Last |
| | | | Name, Q1 = 1^{st} & Current |
| | | | Married Last Name |
| | | 4 D-NAM Value | 2\|Rosa María Muñoz Gómez |
| | | Modifiers: | |

Note that one might choose between either of two different versions of her name when printing the name and each is shown in detail in the two different occurrences of the “Z” SFC.
Explanation of the Above Content:

We can see that Rosa Maria has married, and that her current Husband's Last name is: Gómez, we can also readily see that her First or Given Name is: Rosa Maria, and that her Father's Last name is: Muñoz, and finally we can see that her mother's maiden name is: Izquierdo. Note also that using the Global or G-SFC there is a Date that has been attached or inserted into the record. If you look at the detailed example of all of the SFCs for Personal Name, you will not find any reference to Dates, nor any reference specifically to: G_Date_{—}237. This example illustrates that G-SFCs may be added or applied in the Data Load/as a “Birth” date. Note that we have also included the “H” SFC, which is the Academic Suffix, showing that this person has an Academic Suffix with a value of: Ph.D.

Note that G-SFCs are defined in C²D² and are used to facilitate added clarity and to provide additional detail for SFCs. In this example, the G-SFC for the 237^{th} unique format for representation of Date is added during the Data Load/Update phase and with the Indicator values shown we can readily see that this is indicating a substantial name change to both the First and the Last names. Therefore, we can clearly see that this G-SFC is a DATE, and we know how to parse the date string so that we can interpret it correctly.

Turning now to a sample name: Rosa Maria Muñoz Izquierdo. Rosa Maria is the woman's name—nombre or nombre cristiano. Maria is not her middle name—it is part of what we would call her first name. Muñoz is her father's last name—or apellido paterno—this is what we would call her “last name”! Izquierdo is her mother's last name (maiden name)—or apellido materno—and is used only in conjunction with her father's last name. It is not what we would call her ‘last name’. It is only part of her complete last name. So, we can call her Rosa Maria Muñoz, Rosa Maria Muñoz Izquierdo, señora Muñoz or Ms. Muñoz Izquierdo. But we do not call her Ms. Izquierdo! This can be complicated when a woman marries. Let's say Rosa Maria marries Ramón Gómez González. She will take Ramón's paternal last name (the first of his two last names.). Many Hispanic countries use the conjunction ‘de’ to show it is a married last name. Rosa Maria Muñoz Izquierdo is now called any of the following: Rosa Maria Muñoz de Gómez; Rosa Maria Muñoz Izquierdo de Gómez; and Rosa Maria Muñoz Gómez. Her primary last name is still Muñoz.

When Ramón Gómez González and Rosa Maria Muñoz Izquierdo have a son, Mauricio Raúl, his full name will be Mauricio Raúl Gómez Muñoz. Their daughter Patricia Luisa's full name is Patricia Luisa Gómez Muñoz.

This is a non-limiting example of some embodiments of the present invention of the DATA Representations using only a few of the data element structures extracted from all of the many potential data elements for Personal Name in C²D², that shows how it may be applied for the storage or transmission of real data. This is an example of the Field and SFC descriptions for a “Personal Name” and how it would be used to represent one famous person who changed his name and how that would be represented via the constructs available within C²D².

Field: Personal Name
Indicators:

| Ind | SHORT | LONG/DESCRIPTION | Actual Data |
|---|---|---|---|
| 0 | CC | Composite Current | CC, then “blanked” |
| 1 | REPEAT | Repeating is permitted | 1 |
| 2 | LANG | Language Code (ISO 639-2) | eng |

Modifiers:
Sub-Field Codes (SFCs):

| SFC | SHORT | LONG/DESCRIPTION | Actual Data |
|---|---|---|---|
| B | LN | Last Name or Family Name | Clay |
| D | FN | First or Given Name | Cassius |

G_Date_237 Ind: 6|Date = DD:MM:YYYY format 6|17:01:1942

Global Indicators for G-SFC “G_Date_237” are:

| | | |
|---|---|---|
| E | Event Indicator: 1 = Birth | E1 |

Modifiers for G-SFC “G_Date_237” are:
<None>

Explanation of the above content:

We can see that the Last name of the individual is: Clay, we can also see that the First or Given Name is: Cassius. Note also that using the Global SFC there is a Date that is attached or inserted into the record. Note also that if you look at the detailed example of all of the SFCs for Personal Name, you will not find any reference to Date nor any reference specifically to: G_Date_{—}237. This example illustrates that G-SFCs may be added or applied in the Data Load/Update or processing phase. Therefore, G-SFCs may be applied to, or associated with any appropriate Standard SFC.

Note that G-SFCs are defined in C²D² and are used to facilitate added clarity and to provide additional detail for a SFC. In this example, the G-SFC for the 237^{th} representation of Date is added during the Data Load/Update phase and with the Indicator values shown we can readily see that this is Mr. Clay's birth date. Therefore, we can clearly see that this G-SFC is a DATE, and we know how to parse the date string to interpret it correctly, but what kind of date is it? What is this date all about? The answer to that questions if found in the Event Indicators table within C²D².

This next example contained in some embodiments of the present invention is a sample of the SFC descriptions for the Field: “WBC-Count” and it is provided to convey basic concepts concerning the structure used for specifying all of the SFCs (note that G-SFCs are not shown here at all) for the Field: “WBC-Count” within C²D². Note also that as a rule of thumb, the “A” SFC for most Fields is generally reserved for storing data as a string such as we may presently have it (in what ever form that it may be in, and no matter how nebulous, un-interpretable, or un-parsable it may be). In other words, unfortunately today, a lot of medical data in its present form may not be easily parsed for storage into Atomic-level data elements. Therefore, we must be able to, have as it were a convenient “container,” into which we may hold any “fuzzy” data, regardless of the form it may take. So the “A” SFC as shown below is used for this purpose. Note also that this approach enables us to take what data may now exist, and allows us to put it into the same Field/SFC structure as described by C²D². But C²D² also provides the generalized structure which is capable of supporting the full Atomic-level data definition structures to be used as applicable. This approach permits all “fuzzy” data to remain in its present state stored in the “A” SFC, until such time that we can fully understand how to break it apart, and place the components of the data string into the appropriate Atomic-level data elements. Note that cows, dogs, other vertebrates have blood and that medical researchers and veterinarians perform blood tests on these as well, therefore the Indicators 3-8 delineate the taxonomy of the organism (e.g. human) from which the blood specimen was drawn. Therefore, only the 8^{th} Indicator need be present or it could even be assumed (if not explicitly stated) as the default for typical healthcare applications.

Field: WBC-Count

| Indicators: | | |
|---|---|---|
| 0 | Composite Current, Auto-Replicate . . . | |
| 1 | Repeating | |
| 2 | Language (ISO 639.2) | [List is Maintained by LoC] |
| | http://www.loc.gov/standards/iso639-2/ | |
| | langcodes.html#cd | |
| | http://www.loc.gov/standards/ | |
| 3 | Phylum | Chordata |
| 4 | Class | Mammalia |
| 5 | Order | Primates |
| 6 | Family | Hominidae |
| 7 | Genus | Homo |
| 8 | Species | sapiens |
| Modifiers: | | |
| 1 | | |

Sub-Field Codes (SFCs)

| SFC | SHORT | LONG/DESCRIPTION | EXAMPLE |
|---|---|---|---|
| A | WBC | WBC-Count, such as it exists | >4000.00 |
| B | UNIT | Cells (lowest unit = 1 WB Cell) | WB Cells per . . . |
| C | PER | Measured per what . . . | |
| | | Indicators: | |
| | | 1 Repeating SFC | |
| | | 2 Sequence | Sequence of |
| | | | “per-measure” |
| | | 3 PER Value | μL (microliter) |
| | | | of blood |
| | | Modifiers: | |
| D | CNT | Actual Count of SFC: B (WB Cells) | 4,700 |
| E | METH | Method used to derive SFC: D | manual, |
| | | | impedence, |
| | | | flow-cyt |
| F | S-MD | Sub-division of method | |
| | | Indicators: | |
| | | 1 Repeating SFC | |
| | | 2 Sequence | Sequence of |
| | | | sub-div. |
| | | | method |
| | | 3 S-MD Value | perox, or Baso |
| | | Modifiers: | |
| Z | DISP | Typical Displayable WBC Count | 4700/μL |

Note that G-SFCs are defined and applied for Global use, meaning that they are frequently only applied within the Data Load/Update phase (in Lower-right Quadrant) and the G-SFCs are therefore NOT usually shown in the Data Element Definition section of C²D².

Thus, as discussed herein, the embodiments of the present invention embrace a system and method for taking data from a known source, breaking it down into its most generic, atomic form, and in so doing removing all ambiguity, and translating the generic data into any type of application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for obtaining unambiguous, atomic level data comprising the steps for:
locating personal data from a known source;
breaking the personal data down into its most generic, atomic form and in so doing, removing all ambiguity as to the accuracy and semantic meaning of the data related to the person such that there can be no ambiguity as to the identity of the person; and
translating the data into any type of application.

2. The method of claim 1, wherein the application is any type of computer application.

3. The method of claim 1, further comprising the step of enabling interoperability between disparate computer systems.

4. The method of claim 1, wherein locating the personal data from a known place takes place without the assistance from the vendors who provide those systems.

5. A computer program product for implementing within a computer system a method for obtaining unambiguous, atomic level data, the computer program product comprising:
a computer readable medium for providing computer program code means utilized to implement the method, wherein the computer program code means is comprised of executable code for implementing the steps for:
locating personal data from a known source;
breaking the personal data down into its most generic, atomic form and in so doing, removing all ambiguity as to the accuracy and semantic meaning of the data related to the person such that there can be no ambiguity as to the identity of the person; and
translating the data into any type of application.

6. The computer program product of claim 5, further comprising the step of enabling interoperability between disparate computer systems.

7. The computer program product of claim 5, wherein locating the personal data from a known place takes place without the assistance from the vendors who provide those systems.

8. A method for obtaining unambiguous, atomic level data comprising the steps for:
locating data from a known source;
breaking the data down into its most generic, atomic form and in so doing, removing all ambiguity as to the accuracy and semantic meaning of the data such that there can be no ambiguity as to the data's accuracy and semantic meaning; and
translating the data into any type of application.

9. The method of claim 8, wherein the application is any type of computer application.

10. The method of claim 8, further comprising the step of enabling interoperability between disparate computer systems.

11. The method of claim 8, wherein locating the data from a known place takes place without the assistance from the vendors who provide those systems.
